(19) United States
(12) Patent Application Publication
(10) Pub. No.: US 2007/0072441 A1
(43) Pub. Date: Mar. 29, 2007

(54) Vehicle having rapid electric power connection

(75) Inventor: Feng-Chu Chang, Hsin Chang City (TW)

Correspondence Address: NIKOLAI & MERSEREAU, P.A., 900 SECOND AVENUE SOUTH, SUITE 820, MINNEAPOLIS, MN, 55402, US

(73) Assignee: CHIENTI ENTERPRISE CO., LTD., Hsin Chang City (TW)

(21) Appl. No.: 11/235,720

(22) Filed: Sep. 26, 2005

(51) Int. Cl. H01R 33/00

(52) U.S. Cl. 439/35

(57) ABSTRACT

A vehicle includes vehicle body having a front body and a rear body, a front receptacle mounted on the front body, a rear receptacle mounted on the rear body, and two energized plates mounted on the front receptacle and inserted into the rear receptacle when the rear body is combined with the front body so that the rear receptacle is electrically connected to the front receptacle to form an electrical connection between the front body and the rear body. Thus, when the rear body is combined with the front body, the front body and the rear body form an electrical connection synchronously, so that the electric power of the vehicle is conducted easily and rapidly.

### BACKGROUND OF THE INVENTION

1. Field of the Invention

The present invention relates to a vehicle, and more particularly to a vehicle, such as a motorcycle, scooter, automotive vehicle, motorized vehicle and the like.

2. Description of the Related Art

A conventional vehicle comprises a vehicle body including a front body and a rear body combined with the front body by soldering. The front body has front electric wires, and the rear body has rear electric wires connected to the front electric wires of the front body by terminals. However, the front electric wires of the front body are connected with the rear electric wires of the rear body by soldering to prevent detachment of the terminals, thereby wasting the working time and increasing costs of assembly, and thereby causing inconvenience to an operator when combining the front body and the rear body.

### SUMMARY OF THE INVENTION

In accordance with the present invention, there is provided a vehicle, comprising a vehicle body including a front body and a rear body, a front receptacle mounted on the front body, a rear receptacle mounted on the rear body, and two energized plates mounted on the front receptacle and inserted into the rear receptacle when the rear body is combined with the front body so that the rear receptacle is electrically connected to the front receptacle to form an electrical connection between the front body and the rear body.

The primary objective of the present invention is to provide a vehicle having a rapid electric power connection.

Another objective of the present invention is to provide a vehicle, wherein when the rear body is combined with the front body, the front body and the rear body form an electrical connection synchronously, so that the electric power of the vehicle is conducted easily and rapidly, thereby facilitating an operator mounting the electric connection of the vehicle.

A further objective of the present invention is to provide a vehicle, wherein the front receptacle is electrically connected to the conducting wires of the front body and the rear receptacle is electrically connected to the conducting wires of the rear body so that when the rear receptacle is electrically connected to the front receptacle, the rear body and the front body form an electrical connection synchronously so as to conduct the electric power of the vehicle easily and rapidly.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a vehicle in accordance with the preferred embodiment of the present invention.

FIG. 2 is a partially exploded perspective view of the vehicle as shown in FIG. 1.

FIG. 3 is a partially exploded perspective view of the vehicle as shown in FIG. 1.

FIG. 4 is a partially exploded perspective view of the vehicle as shown in FIG. 1.

FIG. 5 is a locally enlarged view of the vehicle as shown in FIG. 4.

### DETAILED DESCRIPTION OF THE INVENTION

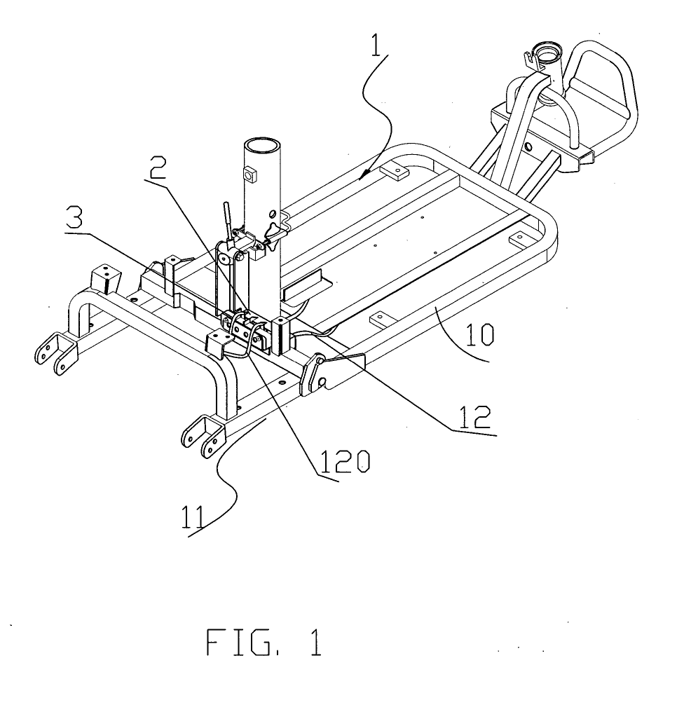

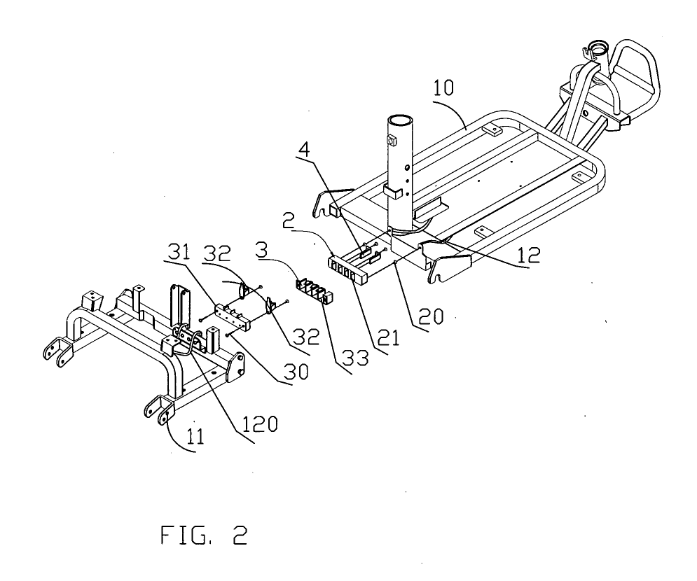

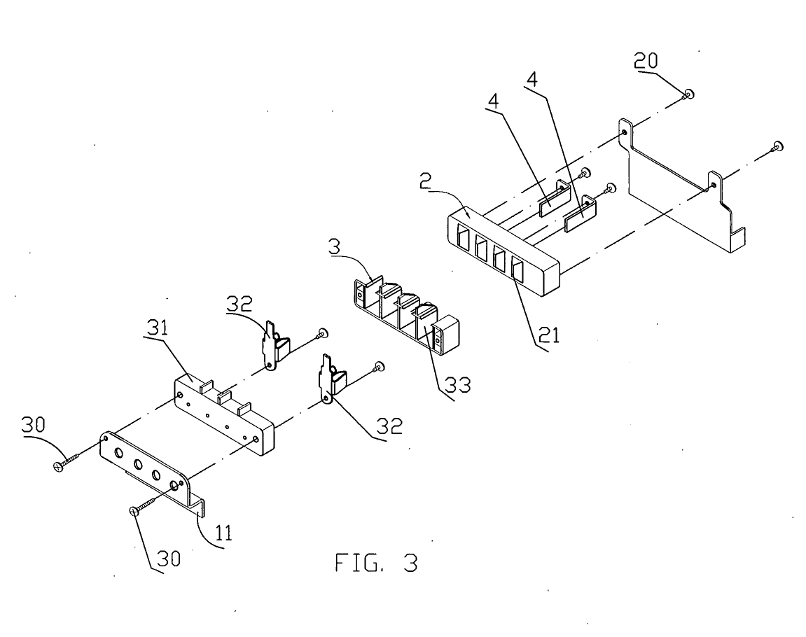

Referring to the drawings and initially to FIGS. 1-3, a vehicle in accordance with the preferred embodiment of the present invention comprises a vehicle body 1 including a front body 10 and a rear body 11, a front receptacle 2 mounted on the front body 10, a rear receptacle 3 mounted on the rear body 11, and two energized plates 4 mounted on the front receptacle 2 and inserted into the rear receptacle 3 when the rear body 11 is combined with the front body 10 so that the rear receptacle 3 is electrically connected to the front receptacle 2 to form an electrical connection between the front body 10 and the rear body 11.

The front body 10 of the vehicle body 1 has two conducting wires 12, and the rear body 11 of the vehicle body 1 has two conducting wires 120. Preferably, a housing (not shown) is mounted on the top of the vehicle body 1.

The front receptacle 2 is mounted on a rear portion of the front body 10 by a plurality of locking screws 20. The front receptacle 2 has a plurality of slots 21 to allow insertion of the energized plates 4 so as to conduct an electric power. The front receptacle 2 is electrically connected to the conducting wires 12 of the front body 10 so that the front receptacle 2 is electrically connected to the front body 10.

The rear receptacle 3 is mounted on a front portion of the rear body 11 by a plurality of locking screws 30. The rear receptacle 3 has a plurality of slots 33 to allow insertion of the energized plates 4 so as to conduct an electric power. The rear receptacle 3 is electrically connected to the conducting wires 120 of the rear body 11 so that the rear receptacle 3 is electrically connected to the rear body 11.

The vehicle further comprises a seat plate 31 having a conductive feature mounted on the front portion of the rear body 11 to support the rear receptacle 3, and two conductive plates 32 inserted into the slots 33 of the rear receptacle 3 and electrically connected to the energized plates 4 when the rear body 11 is combined with the front body 10. The conductive plates 32 are located at a front side of the seat plate 31 and electrically connected to the conducting wires 120 of the rear body 11.

The energized plates 4 are electrically connected to the conducting wires 12 of the front body 10. The energized plates 4 are in turn inserted into the front receptacle 2 and the rear receptacle 3. Preferably, the energized plates 4 are initially inserted into the slots 21 of the front receptacle 2 and inserted into the slots 33 of the rear receptacle 3 when the rear body 11 is combined with the front body 10. Each of the energized plates 4 is a sheet-shaped steel plate that can conduct the circuit.

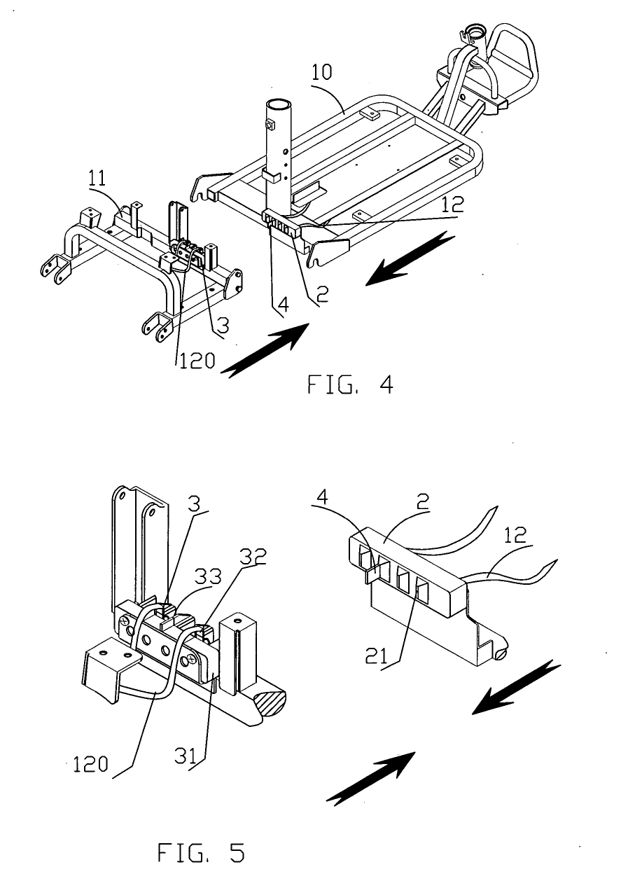

Referring to FIGS. 1-5, when the rear body 11 is combined with the front body 10, the energized plates 4 initially inserted into the slots 21 of the front receptacle 2 are inserted into the slots 33 of the rear receptacle 3 so that the rear receptacle 3 is electrically connected to the front receptacle 2 to form an electrical connection between the front body 10 and the rear body 11.

Accordingly, when the rear body 11 is combined with the front body 10, the front body 10 and the rear body 11 form an electrical connection synchronously, so that the electric power of the vehicle is conducted easily and rapidly, thereby facilitating an operator mounting the electric connection of the vehicle. In addition, the front receptacle 2 is electrically connected to the conducting wires 12 of the front body 10 and the rear receptacle 3 is electrically connected to the conducting wires 120 of the rear body 11 so that when the rear receptacle 3 is electrically connected to the front receptacle 2, the rear body 11 and the front body 10 form an electrical connection synchronously so as to conduct the electric power of the vehicle easily and rapidly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A vehicle, comprising:
a vehicle body including a front body and a rear body detachably combined with the front body;
a front receptacle mounted on a rear portion of the front body;
a rear receptacle mounted on a front portion of the rear body;
two energized plates mounted on and electrically connected to the front receptacle and detachably inserted into and electrically connected to the rear receptacle when the rear body is combined with the front body so that the rear receptacle is electrically connected to the front receptacle to form an electrical connection between the front body and the rear body;
the front receptacle having a wall formed with a plurality of slots to allow insertion of the energized plates;
the rear receptacle having a wall formed with a plurality of slots to allow insertion of the energized plates;
two conductive plates detachably inserted into the slots of the rear receptacle and electrically connected to the energized plates when the rear body is combined with the front body and when the energized plates is inserted into the rear receptacle;
wherein the front body of the vehicle body has two conducting wires;
the rear body of the vehicle body has two conducting wires;
the front receptacle is electrically connected to the conducting wires of the front body so that the front receptacle is electrically connected to the front body;
the rear receptacle is electrically connected to the conducting wires of the rear body so that the rear receptacle is electrically connected to the rear body;
the energized plates are electrically connected to the conducting wires of the front body.

2. The vehicle in accordance with claim 1, wherein the front receptacle is mounted on the rear portion of the front body by a plurality of locking screws which are extended through the rear portion of the front body and screwed into the front receptacle.

3. (canceled)

4. The vehicle in accordance with claim 1, wherein the rear receptacle is mounted on the front portion of the rear body by a plurality of locking screws which are extended through the front portion of the rear body and screwed into the rear receptacle.

5. (canceled)

6. (canceled)

7. The vehicle in accordance with claim 1, wherein the conductive plates are located between the front portion of the rear body and the rear receptacle and electrically connected to the conducting wires of the rear body.

8. The vehicle in accordance with claim 1, further comprising a seat plate mounted on the front portion of the rear body and located between the front portion of the rear body and the rear receptacle to support the rear receptacle.

9. The vehicle in accordance with claim 8, wherein the conductive plates are located at a front side of the seat plate and located between the seat plate and the rear receptacle.

10. The vehicle in accordance with claim 8, wherein the seat plate has an electrically conductive feature.

11. (canceled)

12. The vehicle in accordance with claim 1, wherein the energized plates are initially inserted into and locked in the slots of the front receptacle and then inserted into the slots of the rear receptacle when the rear body is combined with the front body.

13. The vehicle in accordance with claim 1, wherein each of the energized plates is a sheet-shaped steel plate having a substantially L-shaped cross-sectional profile.

14. (canceled)

15. (canceled)

16. The vehicle in accordance with claim 1, wherein when the rear body is combined with the front body, the front body and the rear body form an electrical connection synchronously by insertion of the energized plates on the front receptacle into the rear receptacle.

17. The vehicle in accordance with claim 1, wherein the front receptacle is electrically connected to the conducting wires of the front body and the rear receptacle is electrically connected to the conducting wires of the rear body so that when the rear receptacle is electrically connected to the front receptacle by connection of the energized plates, the rear body and the front body form an electrical connection synchronously so as to conduct the electric power of the vehicle.
